(19) United States
(12) Patent Application Publication
(10) Pub. No.: US 2020/0341718 A1
(43) Pub. Date: Oct. 29, 2020

(54) CONTROL SYSTEM FOR AUDIO PRODUCTION

(71) Applicant: ILIO Enterprises, LLC, Westlake Village, CA (US)

(72) Inventors: Mark David Hiskey, Malibu, CA (US); Eran Weinberg, Los Angeles, CA (US); Tamas Domonkos, II-Hemel (MT)

(21) Appl. No.: 16/669,223

(22) Filed: Oct. 30, 2019

Related U.S. Application Data
(63) Continuation-in-part of application No. 15/858,225, filed on Dec. 29, 2017, now abandoned.
(60) Provisional application No. 62/440,895, filed on Dec. 30, 2016.

(51) Int. Cl. G06F 3/16; G11B 27/028; G06F 3/0488; G06F 3/0482; G06F 9/445

(52) U.S. Cl. CPC G06F 3/162; G11B 27/028; G06F 9/44526; G06F 3/0482; G06F 3/04883

(57) ABSTRACT

A touch control audio interface system comprising: a tactile control surface; a first computer running a DAW; a second computer running a software application; plug-ins. The system allows the tactile control surface, which includes analog dials and switches to control the plug-in, rather than having to control the plug-in using the MIDI, DAW, or plug-in virtual controls.

### CROSS REFERENCE PARAGRAPH

This U.S. Non-Provisional Patent Application is a continuation-in-part of U.S. patent application Ser. No. 15/858,225, filed on Dec. 29, 2017, titled “Control System For Audio Production”, the contents of which are expressly incorporated herein by this reference and to which priority is claimed. U.S. patent application Ser. No. 15/858,225 claims the benefit of and priority to U.S. Provisional Patent Application No. 62/440,895, filed on Dec. 30, 2017, titled “Control System For Audio Production”, the contents of which are expressly incorporated herein by this reference and to which priority is claimed.

### FIELD OF USE

The present disclosure generally relates to the field of creative production software control solutions. More specifically, the present disclosure generally relates to a system for providing universal, reliable, and repeatable tactile control of software, namely audio plug-ins, using a hardware device.

### BACKGROUND

Modern music producers often create music on a computer using a Digital Audio Workstation (“DAW”). The benefits of DAWs are numerous, but chief among them are excellent sound quality for a moderate price, instant storage and retrieval, portability via file sharing, nearly limitless tracks and expandability depending on the power of the host computer, boundless creativity due to the variety and quality of plug-ins that are available, and the ability to record, re-record, edit and mix music easily and non-destructively. An audio plug-in, generally, is a plug-in program that can add or enhance audio-related functionality in a computer program. Such functionality may include digital signal processing or sound synthesis. Audio plug-ins usually provide their own user interface, which often contains graphical user interface (GUI) widgets that can be used to control and visualize the plug-in's audio parameters.

Most DAWs support the use of plug-ins, which enhance the power of a DAW by providing creative and varied options for music creation. Plug-ins are typically developed by third party developers separately from DAW developers. Because plug-ins are developed by a multitude of independent developers, the parameter controls and interface conventions may vary widely from plug-in to plug-in. For example, some plug-ins provide access to parameter settings via external Musical Instrument Digital Interface (“MIDI”) control and others do not, or some utilize keyboard data entry while others do not. There is very little consistency in user-interfaces from plug-in to plug-in, and they often require the user to “hunt and peck” with a computer mouse to learn and relearn functions.

In addition, the computer mouse is often not the optimal device for interfacing with plug-ins. Most plug-ins have attractive designs that are visually analogous to the hardware devices they emulate. For example, a compressor plug-in interface may be designed with stylized black knobs, old voltage meters and a brushed steel surface to closely resemble a desirable vintage hardware compressor. A virtual synthesizer may have the exact same knob and slider design as its corresponding real-world version, or it may have a non-derivative modern design with translucent graphic elements, and so on. Developers apply significant thought and resources to graphical user interface (“GUI”) design as a way of differentiating their products and as an indicator of the quality of sound their plug-ins can create. Using a mouse to adjust the parameters of these plug-ins is counter-intuitive. Typically, users must adjust a parameter by clicking on a virtual knob on the interface and dragging the mouse up or down along the y axis that bisects the knob. At best, this is unsatisfying as there may be no correlation between the vertical movement of the mouse and the rotary action of the knob. In addition, some parameters are very small graphically, while others require drawing, and in both cases manipulating them can be difficult using a mouse.

Recognizing the market preference for hands-on control, the music products industry has created a number of hardware MIDI controllers intended to provide tactile control of software. These controllers typically include rotary knobs, dials, push buttons, rotatable switches, flip switches, analog sticks, sliders, and faders that may be assigned to software parameters via the MIDI protocol. They tend to fall short of expectations for a variety of reasons. One reason is that when a hardware control does not correlate intuitively with a software control, the user experiences a cognitive disconnect that results in a workflow disruption.

Some controller manufacturers have attempted to meet this challenge by labeling the controls with small LED or LCD screens, wherein the display on the screens can change depending on the software or parameter controlled. While this solution helps to identify the correct control, it requires that the user repeatedly shift attention from the computer screen to the controller surface and back again. In optimal conditions, the computer screen may be one or two feet away from the controller requiring the user to continually move his or her head and refocus, which is another significant workflow disruption.

Users may elect to use a second computer screen or tablet computer functioning as a second screen to display plug-in interfaces. Such use requires the user to physically “click and drag” the plug-in interface to the second screen and resize the interface for optimal resolution using mouse control.

Additionally, because current plug-ins are created by hundreds of different developers, each with different methods of assigning external control, or in many cases no external control at all, there is a vast discrepancy in the way physical controls are assigned to software parameters, and in many cases those assignments simply cannot be made. Often, the user must re-assign parameters to controls as these assignments are saved within one track or session and not within the plug-in itself. Due to these challenges, the user often forgoes using physical controls in favor of using a mouse, even though the mouse is not optimal.

Another challenge concerns plug-in management. With many thousands of plug-ins available on the market, a single user may have a hundred or more plug-ins installed in his system. Further, plug-ins fall under a number of different use categories, such as compressor, EQ (equalization), reverb, synthesizer, drum loops, orchestral, and the like. The categorization of plug-ins is not well-developed in most DAWs and the user must recall from memory what a given plug-in's function is. As a result, the user often resorts to using a small number of installed plug-ins because he or she simply cannot remember what all of them do. Also, in any given project, a user may have dozens and dozens of plug-ins in use at any given time, often with several instances of one plug-in spread across many tracks. With so many open plug-ins, it is very difficult to know intuitively which plug-in is assigned to which track. Many users have a second monitor on their computer systems to display their plug-in windows on a dedicated screen. This may help keep plug-in interfaces from obscuring the DAW interface, but the problem of navigating dozens of plug-in windows remains. Accessing a certain plug-in's controls may be akin to finding a needle in a haystack, particularly in a large, complicated project.

Accordingly, what is needed is a system that does not: dissociate the linear vertical movement of the mouse and rotary movement of software knobs; dissociate physical controllers and software controls; result in workflow disruption due to extraneous head movement and refocusing; cause the user to “click and drag” the plug-in interface to a second screen; require inconsistent (or non-existent) methods of assigning physical controls to software parameters; or cause difficulty in managing the use of and having quick access to plug-ins.

Importantly, systems other than the system of the present disclosure do not solve these issues. For example, U.S. Published Patent Application Nos. 2010/0180224, 2013/0346858, and 2012/0284622, are all directed to audio production control systems, but all three fail to disclose the use of a three-dimensional device with analog controls and they fail to disclose that the control assignments may be saved and recalled in direct association with the plug-in itself, not the DAW, the DAW project, or the preset inside the plug-in. For the user, the workflow advantage is that the controller assignments are recalled every time the plug-in is loaded, regardless of which DAW is used. No presets, templates, or projects have to be loaded to recall the assignments. As such, the assignments can exist independently of the DAW, project and presets. This results in a more predictable, and realistic relationship between the plug-in, the controller, and, as a result, the user.

Furthermore, while these three references discuss displaying plug-in interfaces on a device screen, none of them discuss placing the selected interface at its optimal position and resolution without the need for further manual adjustment by the user.

Additionally, these three references also fail to disclose that when a user assigns the control input, the system automatically saves the assignments so the user does not need to do so. Every time the user opens that plug-in, whether it's within the current project or in a new project, the Control/Parameter assignments may be automatically loaded. This may save the user much time, confusion, and effort from having to re-assign the control input, and will provide a more consistent, reliable experience.

The three references also fail to disclose that the steps for linking the plug-in to the track may comprise: 1) identifying the TCS by the DAW as a Human User Interface Protocol (commonly abbreviated to HUI) (a type of MIDI communications protocol), which uses an open source communication protocol for DAW controllers, to allow the TCS to gain access to the track names, and DAW control functions such as record, play, and other functions; and 2) identifying the track by capturing the plug-in window header. Because the TCS may have access to a wrapped plug-in window, the TCS is able to identify the window name and extract the track name. The TCS may then compare the track name from the header and the track name from the DAW list and create the relationship. When a user activates a wrapped plug-in, the wrapped plug-in may automatically arm the track to which it is assigned. The user may disarm the track if the user so chooses.

The three references also fail to disclose a system, wherein MIDI communication is not used, wherein the parameter assignments may be saved between uses of the plug-in, such that when the plug-in is closed and re-opened, or used in more than one of the channels, each instance of the plug-in retains the assigned parameter values. The three references above clearly and unequivocally do not associate the parameter assignments with the plug-in itself, only a DAW project or template, or a plug-in preset or template.

### SUMMARY

The present specification discloses a system for providing universal, reliable, and repeatable tactile control of software using a hardware device.

One embodiment may be a touch control audio interface system comprising: a first electronic data processing device; a second electronic data processing device; and a tactile control surface; wherein the first electronic data processing device may comprise an input device and first electronic data processing device display; wherein the first electronic data processing device may comprise a digital audio workstation; wherein one or more audio plug-ins may be used within the digital audio workstation, such that the one or more audio plug-ins are accessible via use of the digital audio workstation; wherein the one or more plug-ins may comprise editable audio information; wherein the one or more plug-ins may comprise an audio editing software interface for editing the audio information; wherein the audio editing software interface may comprise digital representations of analog audio editing controls; wherein the second electronic data processing device may comprise a software application and second electronic data processing device display; wherein the software application may be in electronic communication with the digital audio workstation; wherein the tactile control surface may be in electronic communication with the digital audio workstation; wherein the software application may display the one or more audio plug-ins on a display of the second electronic data processing device; wherein the software application may allow for selection of the one or more audio plug-ins via the second electronic data processing device; wherein selecting the one or more audio plug-ins on the second electronic data processing device may display the one or more audio plug-ins; wherein the tactile control surface may comprise three-dimensional (3D) physical input mechanisms; wherein the three-dimensional (3D) physical input mechanisms may comprise assignable tactile interfaces; and wherein one or more of the three-dimensional (3D) physical input mechanisms may be configured to be assignable to portions of the digital representations of analog audio editing controls. The three-dimensional (3D) physical input mechanisms on the tactile control surface may comprise rotary knobs, dials, push buttons, rotatable switches, flip switches, analog sticks, sliders, and faders. The tactile control surface may also comprise a large rotary control knob that is unassignable. The input mechanisms may comprise a dedicated push button to enable the permanent assignment of digital representations of analog editing controls (this is sometimes euphemistically referred to as a “learn” or “memory” button). One or more of the three-dimensional (3D) physical input mechanisms may be configured to be assignable to portions of the digital representations of analog audio mixing controls through use of the dedicated push button to enable the permanent assignment of digital representations of analog editing controls. The three-dimensional (3D) physical input mechanisms may comprise indicators that the one or more of the three-dimensional (3D) physical input mechanisms are assigned to portions of the digital representations of analog audio editing controls. The assignments of the three-dimensional (3D) physical input mechanisms to digital representations of analog audio editing controls may be saved to a profile and are loadable when the one or more audio plugins are active. The knobs, push buttons, switches, and touch sliders on the tactile control surface may not be connected to the digital audio workstation via a MIDI controller communication protocol. The second electronic data processing device may be a tablet. The second electronic data processing device display may be located directly behind the tactile control surface. The tactile control surface may be in electronic communication with the digital audio workstation via a wired or wireless connection.

Another embodiment may be a method of editing digital audio, the steps comprising: providing a tactile control surface; providing a first software application configured to run on a first electronic data processing device; providing a second software application configured to run on a second electronic data processing device; wherein the first software application may comprise a digital audio workstation; wherein the second software application may be in electronic communication with the digital audio workstation; wherein the tactile control surface may be in electronic communication with the first software application; engaging a mechanism of creating permanent assignments between the knobs, push buttons, switches, and touch sliders on the tactile control surface and the digital representations of analog editing controls by pressing a dedicated push button of the tactile control surface, selecting a digital representation of an analog audio editing tool displayed on the first electronic data processing device or the second electronic data processing device, and pressing a three-dimensional (3D) physical input mechanism on the tactile control surface; and disengaging the assignment function by twice pressing the same dedicated push button of the tactile control surface without selecting a digital representation of an analog audio editing tool displayed on the first electronic data processing device or the second electronic data processing device.

Another embodiment may be a touch control audio interface system comprising: a first electronic data processing device; a second electronic data processing device; and a tactile control surface; wherein the first electronic data processing device may comprise an input device and first electronic data processing device display; wherein the first electronic data processing device may comprise a digital audio workstation; wherein one or more audio plug-ins may be wrapped in the digital audio workstation, such that the one or more audio plug-ins are accessible via use of the digital audio workstation; wherein the one or more plug-ins may comprise editable audio information; wherein the one or more plug-ins may comprise an audio editing software interface for editing the audio information; wherein the audio editing software interface may comprise digital representations of analog audio editing controls; wherein the second electronic data processing device may comprise a software application and second electronic data processing device display; wherein the software application may be in electronic communication with the digital audio workstation; wherein the tactile control surface may be in electronic communication with the digital audio workstation; wherein the software application may display the one or more audio plug-ins on a display of the second electronic data processing device; wherein the software application may allow for selection of the one or more audio plug-ins via the second electronic data processing device; wherein selecting the one or more audio plug-ins on the second electronic data processing device may display the one or more audio plug-ins; wherein the tactile control surface may comprise three-dimensional (3D) physical input mechanisms; wherein the three-dimensional (3D) physical input mechanisms may comprise assignable tactile interfaces; wherein one or more of the three-dimensional (3D) physical input mechanisms may be configured to be assignable to portions of the digital representations of analog audio editing controls; wherein the three-dimensional (3D) physical input mechanisms may comprise rotary knobs, dials, push buttons, rotatable switches, flip switches, analog sticks, sliders, and faders; wherein the tactile control surface may comprise a rotary control knob that is not assignable; wherein the input mechanisms may comprise a dedicated push button that enables creating assignments between specific digital representations of analog audio editing controls and other input mechanisms on the system; wherein one or more of the three-dimensional (3D) physical input mechanisms may be configured to be assignable to portions of the digital representations of analog audio editing controls through use of the dedicated push button mechanism (for learning); wherein the three-dimensional (3D) physical input mechanisms may comprise indicators that the one or more of the three-dimensional (3D) physical input mechanisms are assigned to portions of the digital representations of analog audio editing controls; wherein the assignments of the three-dimensional (3D) physical input mechanisms to digital representations of analog audio editing controls may be saved to a profile and are loadable when the one or more audio plugins are active; wherein the second electronic data processing device may be a tablet; wherein the tactile control surface may be in electronic communication with the digital audio workstation via a wireless connection; and wherein the tactile control surface may be in electronic communication with the digital audio workstation via a wired connection.

In operation, a Touch Control System (“TCS”) may be installed for use on a computer system. The TCS may be installed by: 1) connecting a control surface of the TCS to a computer; 2) downloading and installing an associated TCS Application on a first computer; 3) connecting the first computer to a second computer, which is preferably a touch screen enabled computing device, preferably via WiFi or USB through the connected control surface; 4) installing plug-in wrapper software on the computer; and 5) opening the plug-in wrapper software, and selecting plug-ins to “wrap” or use.

In one embodiment, while creating music in a DAW, a user may create a new track and instantiate a plug-in virtual instrument. Once an instrument interface appears on the computer screen, it may also be available at the optimal position and resolution on the TCS Application on a second computer. When the second computer is a touch enabled device such as a tablet, the touch enabled device may be angled horizontally on a stand behind the tactile control surface. The user may now focus his attention on the virtual instrument interface on the second computer. For example, if the user would like to adjust the filter cutoff frequency of a plug-in instrument, the user may touch the corresponding parameter control. Rather than shifting focus to a mouse in order to adjust the parameter, the user may turn a large (greater than 1.5 inches in diameter) rotary control that is unassignable on the tactile control surface to dial in the value desired. This is the “Tap and Turn” functionality detailed below. Now the user may freely edit and experiment with all parameters of the instrument, enjoying tactile feedback, and working quickly without having to refer to the computer screen or remembering controller assignments. As the user continues editing the instrument, the user may then decide to assign additional parameters to certain controls on the Tactile Control Surface. This may be done easily with a dedicated push button on the Tactile Control Surface. These assignments may be saved to the plug-in and may be recalled any time that specific plug-in is instantiated in a project. In some systems, other than the system of the present disclosure, such as ordinary Musical Instrument Digital Interface (“MIDI”) controllers, the MIDI assignments can be made by selecting a plug-in parameter with a mouse and subsequently selecting a physical MIDI control on the controller. In those cases, the assignments can be saved or recalled within a Digital Audio Workstation (DAW) project or template, or within a program preset or template inside a plug-in. The system of the present disclosure differs from other systems in that the assignments are saved and recalled in direct association with the plug-in itself, not in connection with the DAW, the DAW project, or the preset inside the plug-in. For the user, the workflow advantage is that the controller assignments are recalled every time the plug-in is loaded, regardless of which DAW is used. No presets, templates, or projects have to be loaded to recall the assignments. As such, the assignments can exist independently of the DAW, project and presets. This results in a more predictable, and realistic relationship between the plug-in, the controller, and, as a result, the user.

MIDI is a technical standard that describes a communications protocol, digital interface, and electrical connectors that connect a wide variety of electronic musical instruments, computers, and related audio devices for playing, editing and recording music. A digital audio workstation (DAW) is an electronic device or application software that is used for recording, editing, and producing audio files.

Additionally, as a user continues working and adding plug-ins to the production, the TCS Application may display every plug-in that is called into service on the DAW or the second computer. When the user would like to return to the interface of a previously instantiated plug-in, he may call up a thumbnail view in the TCS Application, visually reference which plug-in to edit by image and/or track name, tap the thumbnail and begin editing. The TCS may automatically display the plug-in interface at its optimal full-screen position and resolution on the second computer screen without the need for further manual adjustment by the user.

One embodiment of the system of the present disclosure using the TCS may comprise: opening the DAW; launching the TCS Application on the second computer; creating a Track and instantiating the wrapped version of the plug-in; editing the plug-in using the TCS Application and the Tactile Control Surface; and switching to different plug-ins using the thumbnail view of the TCS Application.

The term “Tap and Turn” describes the action of selecting a parameter on the first computer's TCS Application and turning a knob on the Tactile Control Surface to make quick adjustments to the parameter value. This action is fast, intuitive, and efficient because there may be an immediate connection between the parameter and the control input (knob, slider, or button). Preferably, the Tactile Control Surface may have a large (diameter of 1.5 inches or greater) rotary control knob that is not assignable that is adapted to this function, and wherein any control input on the hardware device (Tactile Control Surface) is capable of changing the value of the last-chosen parameter on the plug-in.

Alternatively, if the user would like to permanently assign a parameter to one of the assignable knobs, buttons, or touch slider, the user may select the parameter on the first computer, press the dedicated memory/set button on the Tactile Control Surface, then depress or touch one of the control inputs on the hardware (Tactile Control Surface) to save the assignment. That control input assignment may remain in effect (be remembered or “learned”) for that plug-in, regardless of the DAW or project in which it is being used, until the user reassigns the physical control to another parameter within that plug-in.

The TCS may provide a consistent, intuitive method to assign controls to any plug-in, even if the plug-in does not support MIDI input, by potentially bypassing MIDI, enabling a more direct connection between the control input and the parameter, and plug-ins that do not support MIDI learn can be assigned to hardware controls using the TCS. This may be done through a combination of MIDI and standard CDC (communications device class) communication protocols to enable connection between the hardware and software components.

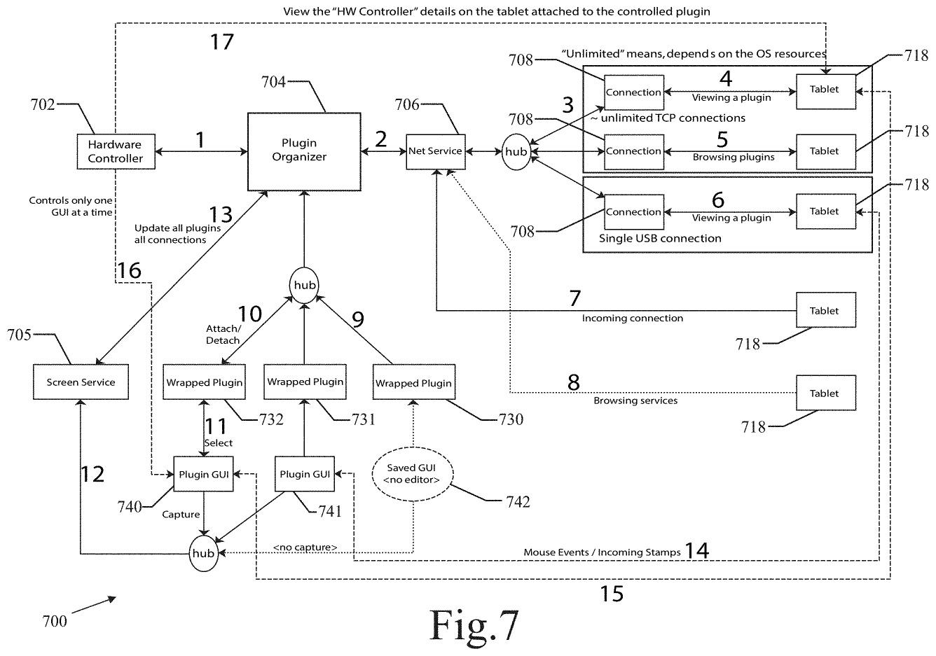

In an embodiment, the plug-in organizer software of the TCS (shown in FIG. 7) may create an external document in the system that stores the control input parameter assignments in a database associated with the plug-in. When a TCS user assigns the control input, the TCS may automatically save the assignments so the user does not need to do so. Every time the user opens the plug-in, whether it's within the current project or in a new project, the Control/Parameter assignments may be automatically loaded. This may save the user time, confusion, and effort from having to re-assign the control input, and will provide a more consistent, reliable experience.

In one embodiment, the software application may display control input assignments and parameter values in a narrow horizontal strip at the bottom of the second computer display. This may be a quick reference that allows the user instant recognition of the control/parameter assignments for the current plug-in.

The close physical proximity of visual and tactile input may simulate working with actual hardware, and may result in a more satisfying, smooth and productive workflow.

The TCS may automatically display the plug-in interface at its optimal full-screen position and resolution on the second computer screen without the need for further manual adjustment by the user.

In the TCS, plug-ins may be viewed in a thumbnail grid format that is easy to filter and search. As the user adds plug-ins in the DAW, plug-in thumbnails can be displayed on the second computer. This may allow the user to easily browse and sort through the plug-ins and filter for plug-ins by name and track. Beyond organizing the plug-ins, the user may quickly hide and launch plug-in windows with the touch of a button.

The TCS may automatically record-enable the selected plug-in's track, and allow the user to assign a track name to the plug-in.

In one embodiment of the present disclosure, the linking the plug-in to the track may comprise: 1) identifying the TCS by the DAW as a Human User Interface Protocol (“HUI”) (a type of MIDI communications protocol), which uses an open source communication protocol for DAW controllers, to allow the TCS to gain access to the track names, and DAW control functions such as record, play, and other functions; and 2) identifying the track by capturing the plug-in window header. Because the TCS may have access to a wrapped plug-in window, the TCS is able to identify the window name and extract the track name. The TCS may then compare the track name from the header and the track name from the DAW list and create the relationship. When a user activates a wrapped plug-in, the wrapped plug-in may automatically arm the track with which it is assigned. The user may disarm the track if the user so chooses.

TCS may be a system for providing universal, reliable, and repeatable tactile control of software using a hardware device (Tactile Control Surface) preferably coupled with a tablet (second computer) display and utilizing network communications, custom software interpolation, screen capture, windows management, and touch screen control.

The TCS of the present disclosure may be a plug-in management solution that improves music production workflow. TCS may simplify the way users manage and modify plug-ins.

These, as well as other components, steps, features, objects, benefits, and advantages, will now become clear from a review of the following detailed description of illustrative embodiments, and of the claim.

### BRIEF DESCRIPTION OF THE ILLUSTRATIVE EMBODIMENTS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

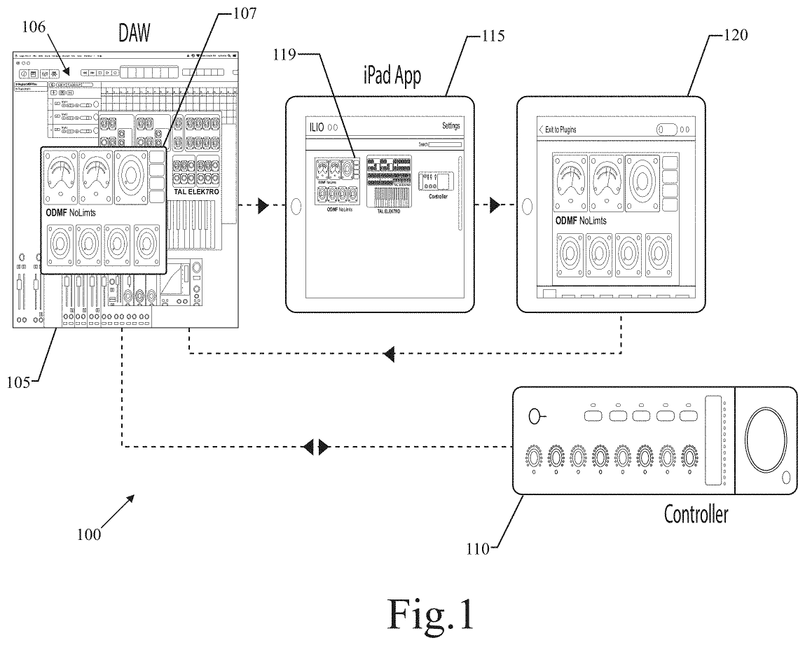

FIG. 1 is a diagram of one embodiment of the touch control audio interface system of the present disclosure.

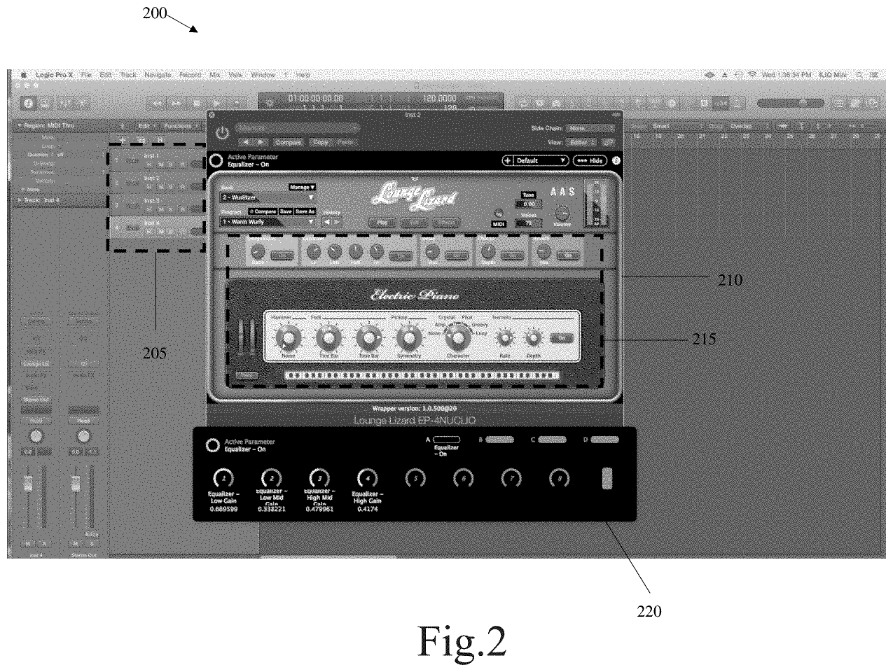

FIG. 2 is a display screen capture of one embodiment of the touch control audio interface system of the present disclosure showing the Digital Audio Workstation with an active plug-in.

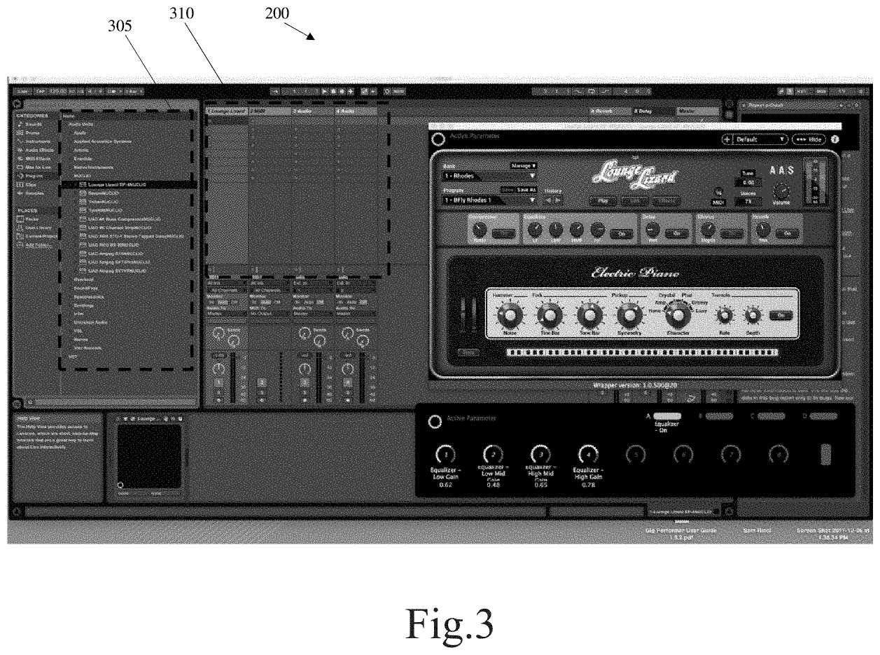

FIG. 3 is a display screen capture of one embodiment of the touch control audio interface system of the present disclosure showing the Digital Audio Workstation with an active plug-in showing in the selection pane.

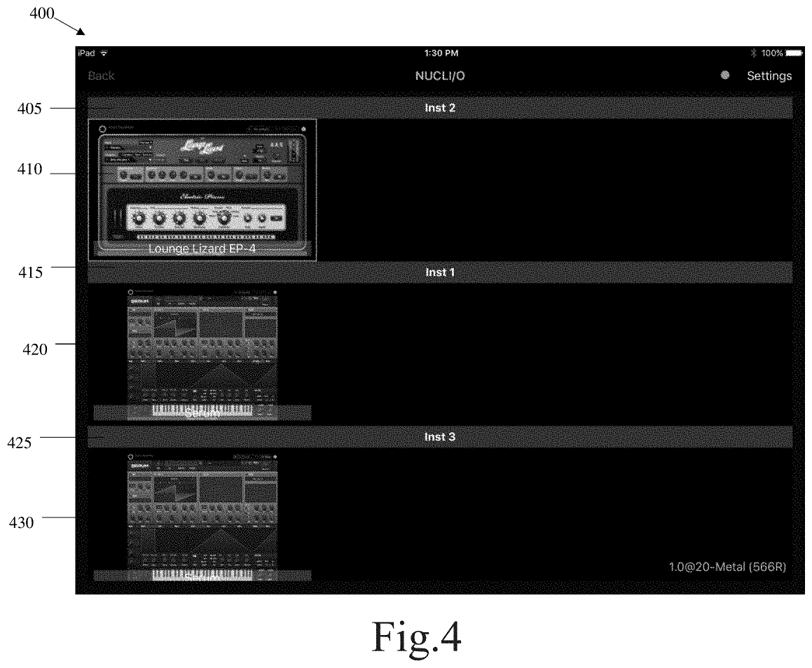

FIG. 4 is a display screen capture of one embodiment of the touch control audio interface system of the present disclosure showing the selection pane on a second computer.

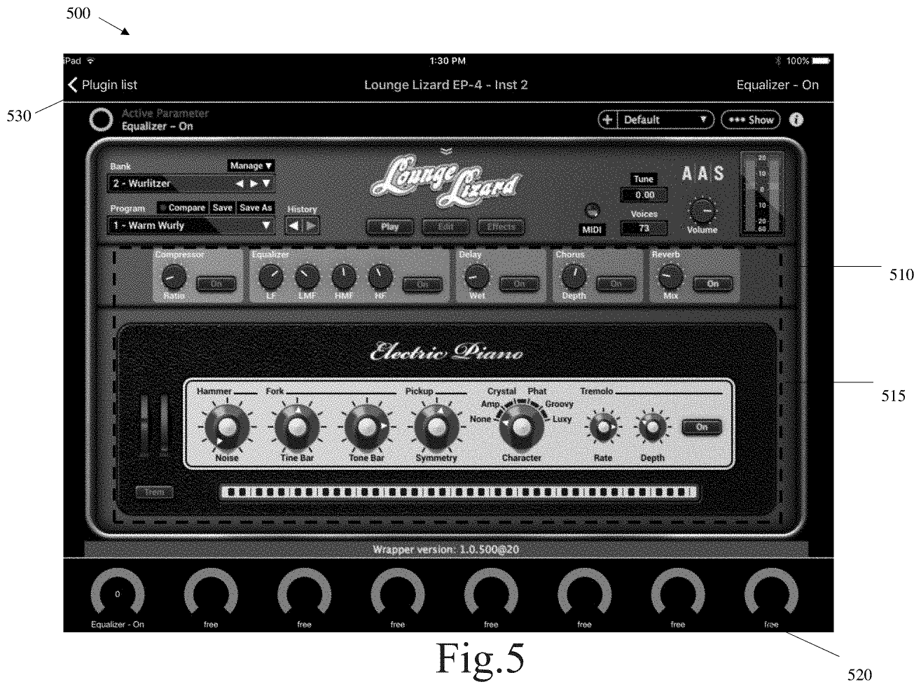

FIG. 5 is a display screen capture of one embodiment of the touch control audio interface system of the present disclosure showing a selected plug-in on the second computer.

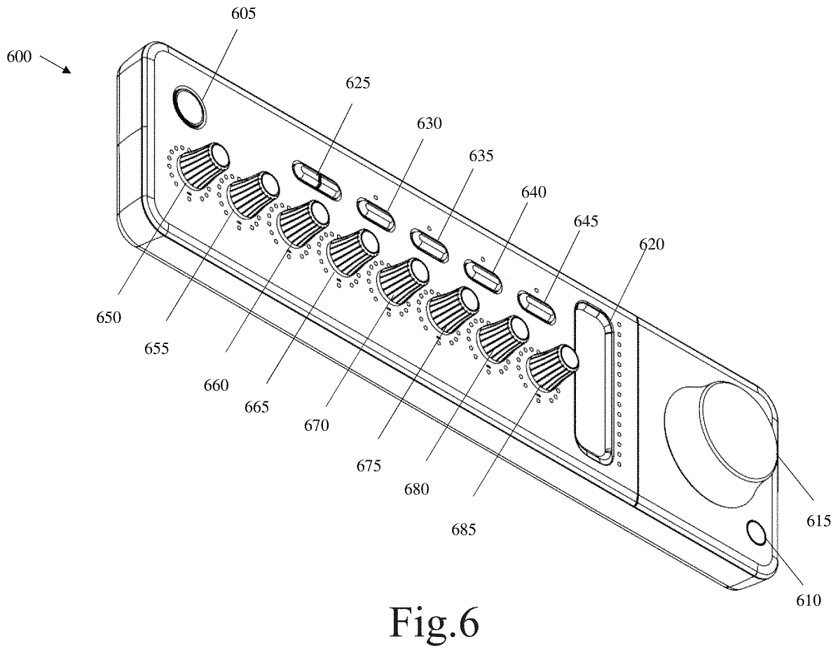

FIG. 6 is an illustration of one embodiment of a tactile control surface of the system of the present disclosure.

FIG. 7 is a flow diagram showing interactions between components of one embodiment of the tactile control system of the system of the present disclosure.

### DETAILED DESCRIPTION OF THE ILLUSTRATIVE EMBODIMENTS

In the following detailed description of various embodiments, numerous specific details are set forth in order to provide a thorough understanding of various aspects of the embodiments. However, these embodiments may be practiced without some or all of these specific details. In other instances, well-known methods, procedures, and/or components have not been described in detail so as not to unnecessarily obscure aspects of the embodiments.

While multiple embodiments are disclosed, still other will become apparent to those skilled in the art from the following detailed description. As will be realized, these embodiments are capable of modifications in various obvious aspects, all without departing from the spirit and scope of protection. Accordingly, the graphs, figures, and the detailed descriptions thereof, are to be regarded as illustrative in nature and not restrictive. Also, the reference or non-reference to a particular embodiment shall not be interpreted to limit the scope of protection.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are signify both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

In the following description, certain terminology is used to describe certain features of the embodiments disclosed herein. For instance, the terms “computer”, “computer system”, “computing device”, mobile computing device”, “electronic data processing unit”, or “server” refer to any device that processes information with an integrated circuit chip, including without limitation, personal computers, mainframe computers, workstations, servers, desktop computers, portable computers, laptop computers, embedded computers, wireless devices, including cellular phones, personal digital assistants, tablets, tablet computers, smart phones, portable game players, wearables, smart devices and hand-held computers.

As used herein, the term “Internet” refers to any collection of networks that utilizes standard protocols, whether Ethernet, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the term “website” refers to any document written in a mark-up language including, but not limited to, hypertext mark-up language (HTML) or virtual reality modeling language (VRML), dynamic HTML, extended mark-up language (XML), wireless markup language (WML), or any other computer languages related thereto, as well as to any collection of such documents reachable through one specific Internet Protocol Address or at one specific World Wide Web site, or any document obtainable through any particular Uniform Resource Locator (URL). Furthermore, the terms “webpage,” “page,” “website,” or “site” refers to any of the various documents and resources on the World Wide Web, in HTML/XHTML format with hypertext links to enable navigation from one page or section to another, or similar such resources used on the Internet.

As used herein the term “Touch Control System” or “TCS”, refers to a system for providing universal, reliable, and repeatable tactile control of software using a hardware device and second computer that may be a mobile device, such as a laptop, tablet, or smartphone.

As used herein the term “Tactile Control Surface” (which is sometimes referred to as a controller) refers to a hardware device that is part of the TCS. The Tactile Control Surface may be of the appropriate size and shape to sit atop a music production desk, atop a controller keyboard, or on a work surface that is typical of a production studio. The Tactile Control Surface may comprise: one large rotary knob that is not assignable, one or more, preferably eight, assignable knobs; one or more, preferably five, assignable push buttons; and one or more, preferably one, assignable touch slider. Additionally, there may be (1) one or more dedicated push buttons used to activate a control assignment function and (2) one or more dedicated view or legend buttons.

As used herein the term “digital audio workstation” or “DAW” refers to an electronic device or computer software application for recording, editing, and producing audio files, such as songs, musical pieces, film scores, human speech, sound effects, and the like.

As used herein the term “GUI” or “Graphical User Interface” refers to the visual user interface design of a plug-in or other software program.

As used herein the term “wrapper” or “wrapped” or “wrap” refers to a software interface/layer that may be between an audio, instrument, and/or effect plug-ins and the DAW. The wrapper creates a shell around the plug-in and provides more options and capabilities for using the plug-in within the DAW.

As used herein the term “instantiate” refers to calling a plug-in into service by loading the plug-in into a DAW Track.

As used herein the term “MIDI” or “Musical Instrument Digital Interface” refers to a technical standard that describes a communication protocol, digital interface, and connectors, and allows a wide variety of electronic musical instruments, computers and other related devices to connect and communicate with one another. MIDI may carry event messages that specify notation, pitch and velocity, control signals for parameters such as volume, vibrato, audio panning, cues, and clock signals that set and synchronize tempo between multiple devices. The messages may be sent via a MIDI cable to other devices where they control sound generation and other features. MIDI may also be emulated in a virtual environment, enabling communication between software components.

As used herein the term “MIDI Controller” is any hardware or software that generates and transmits Musical Instrument Digital Interface (MIDI) data to electronic or digital MIDI-enabled devices, typically to trigger sounds and control parameters for an electronic music performance. The most commonly used MIDI controller is the electronic musical keyboard MIDI controller, which has piano-style keys that may be played like any keyboard instrument. When the keys are pressed, the MIDI controller sends MIDI data about the pitch of the note, the velocity and duration, which may be used to trigger sounds from a MIDI-compatible sound module or synthesizer. Many MIDI controllers also have knobs, sliders, buttons, and touch pads that provide tactile control for software parameters.

As used herein the term “parameter” refers to a variable control in a music software interface whose setting may be changed by the end user to achieve a desired result. A given plug-in may have one or more parameters, or up to over 100 depending on its depth and complexity.

As used herein the term “plug-in” refers to a software program that is loaded within a DAW that greatly enhances the DAW's capabilities. Plug-ins may be typically divided into two groups, effects and virtual instruments. Effects often emulate real-world sound-making hardware such as Equalizers, Compressors, Reverbs, and the like. They may be used in the same way as their hardware counterparts and often offer flexibility due to the nature of software. Virtual instruments are a type of plug-in that are software-based instruments that may be played from within a DAW (and often standalone). A user may access realistic instrument sounds such as drums, piano, electronic keyboards, basses, and more using virtual instruments. Virtual instruments give users access to instruments that they normally would not have access to due to budget or space constraints in their studio. Plug-ins may come in many different formats such as VST, VST3, RTAS, DXI, AAX, and Audio Units. Every DAW is typically compatible with at least one of these formats.

As used herein the term “track” or “digital audio tracks” refers to a stored digital audio recording. A digital audio track works similarly to a tape machine. A user may record a musical performance on a single track using a virtual instrument or record multiple instruments on multiple tracks and then mix them to create a complete musical work. Most DAWs are capable of recording hundreds of tracks in one project.

FIG. 1 is a diagram of one embodiment of the touch control audio interface system. As shown in FIG., the touch control audio interface system 100 may comprise a first computer 105, which may have a DAW 106, which may have plug-in 107. The DAW may be in communication with Tactile Control Surface 110 and a second computer 115, which may be a mobile computing device, such as a touch screen enabled tablet computer. The computer 115 may display a thumbnail 119 of the wrapped plug-in 120, which is the same plug-in as plug-in 107. The user may select the thumbnail 119 and open wrapped plug-in 120, which may appear in its optimal position and resolution on the screen. Preferably, the tactile control surface 110 is in close proximity to the second computer 115, which allows the user to find, view, and touch plug-in parameters in an ergonomic manner.

FIG. 2 shows one embodiment of a DAW 200 with an active plug-in 210. As shown in FIG. 2, the DAW 200 may comprise one or more channels 205, an active plug-in 210, and a legend 220. The DAW 200 may run on a first electronic data processing device 202, such as a computer, server, or cloud server, and function analogously to a multi-track audio editing tool to allow a user to edit audio tracks within the DAW 200.

Plug-ins may be wrapped for use within the DAW 200, and then assigned to specific channels 205. Each of the channels 205 may comprise an audio track and one or more plug-ins 210 may be assigned to the channel 205. A user may select a specific channel 205 in the DAW 200 by use of a standard computer interface device, such as a mouse, trackball, or keyboard. Once a channel 205 is selected by the user, an assigned plug-in 210 may be opened and accessed within the DAW 200, which may then display a plug-in 210 interface to allow a user to edit the audio track in the plug-in 210 using digital audio editing tools 215 contained within the plug-in 210. The digital audio editing tools 215 may be a digital representative of various analog audio editing tools, and these digital audio editing tools 215 may be represented by digital input mechanisms, such as digital rotary knobs, digital push buttons, digital switches, digital touch sliders, digital toggles, and other digital input mechanisms.

The legend 220 may be a digital representation of the tactile control surface (shown in FIGS. 1 and 6 and described further hereinbelow. In an alternative embodiment, the legend 220 may be a component of the plug-in 210. The digital representation of the tactile control surface 220 may comprise one or more digital input mechanisms representing the three-dimensional (3D) physical input mechanisms of the tactile control surface. The legend 220 may indicate (by display) to a user which functions of the plug-in 210 have been assigned to which three-dimensional (3D) physical input mechanisms of the tactile control surface. This is unique to the present disclosure because the controller assignments are displayed on both the tablet screen and on the DAW screen. On the DAW screen, the legend 220 may be attached to the bottom border of the plug-in interface (editing tools 215) regardless of where the plug-in 210 is moved on the screen, for easy referencing. Also, the legend 220 can be displayed or disabled/hidden/closed using a dedicated “view” button on the tactile control surface.

In one embodiment, the digital audio editing tools 215 of the plug-in 210 may be assigned to three-dimensional (3D) physical input mechanisms of the tactile control surface, such that interacting with the three-dimensional (3D) physical input mechanisms cause the digital audio editing tools 215 of the plug-in 210 to be used. In one embodiment of the tactile control system, where a MIDI controller is not used, the parameter assignments may be saved between uses of the plug-in 210, such that, where a plug-in 210 is closed and re-opened, or used in more than one of the channels 205, each instance of the plug-in 210 retains the parameter control assignments.

FIG. 2 shows that plug-in 210 may comprise a digital audio editing tool 215 that comprises a rotary knob that controls volume. A user may then assign the rotary knob that controls volume of the plug-in 210 to a physical rotary knob, or other three-dimensional (3D) physical input mechanism, of the tactile control surface. Once this assignment has been created, the user may utilize the physical rotary knob, or other three-dimensional (3D) physical input mechanism, of the tactile control surface to control the digital audio editing tool in the form of a physical rotary knob that controls volume. This parameter assignment may also be displayed in the legend 220 alongside the digital input mechanism representing the physical rotary knob, or three-dimensional (3D) physical input mechanism, of the tactile control surface so that the user may quickly ascertain which physical input mechanisms of the tactile control surface currently have parameter assignments to the digital audio editing tools 215 of the plug-in 210. Also displayed in the legend 220 alongside the digital input mechanism representing the physical rotary knob, or physical input mechanism, of the tactile control surface may be a numerical value to indicate the setting of the digital audio editing tool 215, such as the number 60 to indicate a value of volume of 60%, or other representative methods.

While digital and physical rotary knobs are used in the above example, additional digital and physical analog input mechanisms may be used, such as rotary knobs, dials, push buttons, rotatable switches, flip switches, analog sticks, sliders, and faders, and other input mechanisms. Furthermore, a user may assign non-corresponding digital input mechanisms to three-dimensional (3D) physical input mechanisms, such as assigning a digital rotary knob to a physical touch slider, if the user so wishes.

FIG. 3 is a screenshot of computer displaying a DAW 300 with a plug-in selection pane. As shown in FIG. 3, the DAW 300 may comprise a list of wrapped plug-ins 305. Once a user has created a channel 310, the user may select a specific plug-in from the list of plug-ins 305 and open that specific plug-in to the channel. The list of plug-ins 305 may be based on plug-ins that were previously wrapped into the DAW 300 to the channel.

FIG. 4 is a screenshot of one embodiment of a plug-in selection screen on a second computer 400. As shown in FIG. 4, the selection screen of the second computer 400 (in this case a tablet screen) may comprise a list of channels available in the DAW 405, 415, 425 and plug-ins 410, 420, 430. The second computer 400 may comprise software application and may be in electronic communication with the first computer that is running the DAW. The DAW may transmit information to the second computer 400, such as information regarding the channels 405, 415, 425, plug-ins 410, 420, 430, and other related settings.

The second computer 400 may transmit information back to the DAW, including user input related to plug-ins that are in the channels of the DAW. The first and second computers may be in electronic communication by wireless, wired, or other electronic communication mechanisms and methods. The channels in the DAW may correspond to the channels 405, 415, 425 listed in the plug-in selection screen of the second computer 400, including related information such as the plug-ins in the channels of the DAW. Changes made to the channels 405, 415, 425 or their plug-ins 410, 420, 430 on the second computer 400 may be conveyed to the DAW on the first computer, wherein the changes made to the channels 405, 415, 425 or their plug-ins 410, 420, 430 on the second computer 400 may be reflected in the channels and plug-ins contained within the DAW.

In one embodiment, the information may be displayed on the second computer 400, including the channels and plug-ins, via a screen mirroring program, which may be part of the DAW software. Changes made to the channels or plug-ins on the second computer 400 may be transmitted to the DAW and may be made to the channels and plug-ins of the DAW.

Within the list of channels 405, 415, 425 displayed, there may be a thumbnail preview of the plug-ins 410, 420, 430 that are contained within the channel 405, 415, 425. The user may select one of the thumbnail previews of the plug-ins 410, 420, 430, such as by tapping on the touch screen of the second computer 400, in order to open the plug-in interface on the second computer 400 (shown in FIG. 5). The thumbnail previews may allow a user to quickly and easily select the desired plug-in 410, 420, 430 based on visual recollection. The thumbnail display also allows users to quickly and intuitively switch between plug-ins 410, 420, 430 for ease of editing audio contained within the respective channels 405, 415, 425.

In an alternative embodiment, any electronic data processing device may be used instead of a tablet, such as a phone, laptop, computer, or other electronic data processing device.

FIG. 5 is a screenshot of one embodiment of a selected plug-in as shown on the second computer 500, in this case a tablet. As shown in FIG. 5, the tablet 500 may display a selected plug-in 510. The selected plug-in 510 may comprise audio editing tools 515, a legend 520, and an option to return to the plug-in selection screen 530. The selected plug-in 510 may be selected through the plug-in selection screen on the tablet 400, as shown in FIG. 4. The user may interact with the selected plug-in 510 on the tablet 500, similarly to how the user would interact with a plug-in in the DAW, and these interactions may be transmitted to the corresponding plug-in of the DAW. The interface preferably appears in its optimal position and resolution on the screen.

In one embodiment, one possible procedure for assigning three-dimensional (3D) physical input mechanisms to digital audio editing tools comprises the steps: 1) actuating a three-dimensional (3D) dedicated memory push-button of the tactile control surface; 2) in the plug-in, either on the DAW or the tablet application, select the desired digital audio editing tool; 3) repeat step 2 until desired assignments are identified; and 4) actuating the three-dimensional (3D) dedicated memory push-button of the tactile control surface to end assignment procedure. In this embodiment, the three-dimensional (3D) physical input mechanisms assigned may be automatically assigned based on availability of the physical input mechanisms for assignment.

In an alternative embodiment, a procedure for assigning three-dimensional (3D) physical input mechanisms to digital audio editing tools may comprise the steps: 1) actuating a three-dimensional (3D) dedicated memory push-button of the tactile control surface; 2) in the plug-in, either on the DAW or the tablet application, selecting the desired digital audio editing tool; 3) selecting the desired three-dimensional (3D) physical input mechanism (of the tactile control surface) to be assigned to the selected digital audio editing tool; 4) repeating steps 2-3 until all desired parameter assignments are identified; and 5) actuating the three-dimensional (3D) dedicated memory push-button of the tactile control surface to end the parameter/matching assignment procedure. In this embodiment, the three-dimensional (3D) physical input mechanisms assigned may be assigned based on the user's specific commands.

Once three-dimensional (3D) physical input mechanisms of the tactile control surface have been assigned to digital audio editing tools, the user may use the three-dimensional (3D) physical input mechanisms of the tactile control surface to control the audio editing tools. Additionally, because MIDI is not used, the assignment may automatically be saved and recalled at a later time for a given plug-in, whether the plug-in is used in the same channel or a different channel, or whether the plug-in is used in the same DAW or a different DAW.

FIG. 6 is an illustration of one embodiment of a tactile control surface 600. As shown in FIG. 6, the tactile control surface 600 may comprise a dedicated memory push button for assigning three-dimensional (3D) physical input controls to plug-in audio editing tools 605 (this is euphemistically referred to has the learn or memory button), physical pre-set selector buttons 625, physical legend button 610, rotary control knob that is not assignable, 615, physical rotary knobs 650, 655, 660, 665, 670, 680, 685, physical push buttons 630, 635, 640, 645, and physical fader 620. The physical rotary knobs 650, 655, 660, 665, 670, 680, 685, physical push buttons 630, 635, 640, 645, and physical fader 620 may be assigned to various virtual audio editing tools as detailed herein and shown in FIG. 5. Alternatively, the tactile control surface 600 may comprise any other three-dimensional (3D) physical input mechanisms, switches, buttons, analog controllers, and the like. The rotary control knob 615 may remain unassigned and be used in conjunction with an active or selected audio editing tool. The physical legend button 610 may be a dedicated view button that is used to toggle on or off (open/close/disable/hide/etc.) the legend on the first or second computer, or both.

The tactile control surface 600 may be connected via wire or wirelessly to the first computer that is running the DAW. In one embodiment, the tactile control surface 600 may be connected to the first computer via universal serial bus.

FIG. 7 is a flow diagram of one embodiment of the system 700 of the present disclosure showing interactions between components of the system. As shown in FIG. 7, the tactile control system may comprise various electronic interactions. Electronic interactions depicted in solid lines in FIG. 7 are direct electronic connections, whereas electronic interactions depicted in dashed lines in FIG. 7 are virtual, implicit, or indirect electronic connections.

FIG. 7 shows that a PluginOrganizer-Hardware Controller connection 1 allows information to be sent to a PluginOrganizer 704 when a Hardware Controller 702, also referred to herein as a tactile control surface or controller, is manipulated or used by a user. This information may include control states, control functions, and controller illumination. The PluginOrganizer 704 may function as a brain of the controller and stores control assignments in a database that is associated with the plug-in object. A PluginOrganizer-NetService connection 2 allows a NetService 706 to manage communication between a tablet 718, tablet software, and the PluginOrganizer 704. A NetService-Tablet Software connection 3 allows bi-directional communication between the PluginOrganizer 704 and the Tablet Software.

A wireless viewing connection 4 allows the plug-in to be displayed on the tablet 718 through TCP/WiFi connections 708. Edits made on the plug-in using tablet controls may be sent to the PluginOrganizer 704. Depending on the operating systems used, there may be numerous wireless viewing interactions.

A thumbnail viewing connection 5 may allow the various plug-ins available in channels of a DAW to be displayed in thumbnail view on the tablet 718. Tablet software may query the PluginOrganizer 704, display thumbnails of active plugins and send plugin selection information back to the PluginOrganizer 704.

A wired viewing connection 6 may function substantially similarly to a combination of the wireless viewing connection 4 and the thumbnail viewing interaction 5, with the primary difference being that the connection is wired, such as through USB, which limits the number of available connections, such as a single connection.

A tablet-NetService connection 7 may allow bi-directional communication between the PluginOrganizer 704 and the tablet 718. The tablet 718 is sometimes referred to as the second computer. A browsing services connection 8 may allow a tablet 718 connected to the NetService 706 via a wireless, or TCP/WiFi, connection to select a desired computer or DAW with which to connect. This browsing services connection 8 may not be required when the tablet is connected via a USB to the DAW computer.

A plugin nesting connection 9 may allow plugins to be nested in wrappers, or wrapped. An attachment connection 10 may allow wrapped plugins to be connected or disconnected from the PluginOrganizer 704. A PluginOrganizer-plugin connection 11 may allow a wrapped plugin 730, 731, 732 to send and receive communications with the PluginOrganizer 704. Data sent from the PluginOrganizer 704 to the wrapped plugin 730, 731, 732 may allow a graphical user interface to be updated based on user input.

A ScreenService-plugin connection 12 may allow data to be transferred between the plugin 730, 731, 732 and ScreenService 705, thereby allowing graphical user interface 740, 741, 742 data to be synced, wherein changes made to the plugin 730, 731, 732 on either the DAW or tablet are reflected in the other. The ScreenService-PluginOrganizer 13 connection ensures all wrapped plugins 730, 731, 732 are updated at all times.

A tablet software-plugin connection 14 may allow for edits made on the tablet 718 to be updated in the plugin 730, 731, 732, and vice versa. Similarly, a tablet thumbnail-plugin connection 15 may allow thumbnails of the plug-in selection screen of the tablet 718 to be updated.

A hardware controller-plugin connection 16 may allow the hardware controller 702 to send input values to the plugin. A hardware controller-tablet software connection 17 may allow the hardware controller 702 to send information to the tablet software indicating that the hardware controller 702 is active.

In a preferred embodiment, the PluginOrganizer 704, NetService 706, wrapped plugin 730, 731, 732, plugin GUI 740, 741, and ScreenService 705 may all be located on a first electronic data processing device (a first computer), as described hereinabove. The tablet 719 and hardware controller 702 may be separate devices.

The foregoing description of the preferred embodiment has been presented for the purposes of illustration and description. While multiple embodiments are disclosed, still other embodiments will become apparent to those skilled in the art from the above detailed description. The disclosed embodiments are capable of modifications in various obvious aspects, all without departing from the spirit and scope of the protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope. It is intended that the scope or protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A touch control audio interface system comprising:
a first electronic data processing device;
a second electronic data processing device; and
a tactile control surface;
wherein said first electronic data processing device comprises a display;
wherein said first electronic data processing device comprises a digital audio workstation and one or more plug-ins;
wherein said one or more plug-ins are wrapped and are accessible though said digital audio workstation;
wherein said one or more plug-ins comprise editable audio information;
wherein said one or more plug-ins comprise an audio editing software interface for editing said audio information;
wherein said audio editing software interface comprises a plurality of digital representations of analog audio editing controls;
wherein said second electronic data processing device comprises a software application and a second electronic data processing device display;
wherein said software application is in electronic communication with said digital audio workstation;
wherein said tactile control surface is in electronic communication with said digital audio workstation and said software application;
wherein said software application displays said one or more plug-ins on said second electronic data processing device display;
wherein said software application is configured to display a list of said one or more plug-ins, such that a user is able to select one of said one or more plug-ins to use;
wherein said selected audio plug-in is displayed on said second electronic data processing device;
wherein said tactile control surface comprises a plurality of three-dimensional physical input mechanisms;
wherein said plurality of digital representations of analog audio editing controls are configured assignable to said plurality of three-dimensional physical input mechanisms, such that one or more parameters of said selected plug-in are assigned to said plurality of three-dimensional physical input mechanisms and such that said user is able to use said selected plug-in via said tactile control surface to edit said audio information; and
wherein said assigning of said one or more parameters of said selected plug-in are saved.

2. The touch control audio interface system of claim 1, wherein said assigning of said one or more parameters are saved, such that when said selected plug-in is closed and then reopened, said one or more parameters of said selected plug-in remain assigned to said plurality of three-dimensional physical input mechanisms in the same manner as when saved.

3. The touch control audio interface system of claim 2, wherein no digital audio workstation presets, templates or projects are required to be loaded to recall said saved assignments.

4. The touch control audio interface system of claim 1, wherein said three-dimensional physical input mechanisms are one or more three-dimensional physical input mechanisms selected from the group of mechanisms consisting of: rotary knobs, dials, push buttons, rotatable switches, flip switches, analog sticks, sliders, faders, and combinations thereof.

5. The touch control audio interface system of claim 1, wherein said list of said one or more plug-ins displayed on said software application of said second electronic data processing unit shows a thumbnail view of each of said one or more plug-ins.

6. The touch control audio interface system of claim 1, wherein said tactile control surface comprises an unassignable rotary input device for setting a value of said one or more parameters.

7. The touch control audio interface system of claim 1, wherein said software application of said second electronic data processing unit comprises one or more databases associated with said plurality of plug-ins, wherein said saved assignments are saved on said one or more databases.

8. The touch control audio interface system of claim 1, wherein the software application of said second electronic data processing unit is configured to display said selected plug-in at a full-screen position on said second electronic data processing unit display automatically without manual adjustment by said user.

9. The touch control audio interface system of claim 1, wherein said software application enables a track of said selected plug-in and allows said user to assign a track name to said selected plug-in.

10. The touch control audio interface system of claim 1, further comprising a legend.

11. The touch control audio interface system of claim 10, wherein said legend is displayed on said second electronic data processing unit display when said selected plug-in is displayed.

12. The touch control audio interface system of claim 11, wherein said legend displays to said user of said one or more parameters of said plug-in have been assigned to which three-dimensional physical input mechanisms of said tactile control surface.

13. The touch control audio interface system of claim 12, wherein said legend is also displayed on said display of said first electronic data processing unit display.

14. The touch control audio interface system of claim 13, wherein on said display of said first electronic data processing unit said legend is at a bottom border of a graphical user interface of said plug-in regardless of where on said display of said first electronic data processing unit said graphical user interface of said plug-in is.

15. The touch control audio interface system of claim 14, wherein said tactile control surface comprises a physical legend button that toggles said legend on and off.

16. The touch control audio interface system of claim 15, wherein said legend displays one or more numerical values that indicate one or more values of said one or more parameters of said selected plug-in.

17. The touch control audio interface system of claim 1, wherein said tactile control surface comprises a dedicated memory push button.

18. The touch control audio interface system of claim 1, wherein said one or more plug-ins are not interfaced with said digital audio workstation via a musical instrument digital interface controller protocol.

19. A touch control audio interface system comprising:
a first electronic data processing device;
a second electronic data processing device;
a tactile control surface; and
a legend;
wherein said first electronic data processing device comprises a display;
wherein said first electronic data processing device comprises a digital audio workstation and one or more plug-ins;
wherein said one or more plug-ins are wrapped and are accessible though said digital audio workstation;
wherein said one or more plug-ins comprise editable audio information;
wherein said one or more plug-ins comprise an audio editing software interface for editing said audio information;
wherein said audio editing software interface comprises a plurality of digital representations of analog audio editing controls;
wherein said second electronic data processing device comprises a software application and a second electronic data processing device display;
wherein said software application is in electronic communication with said digital audio workstation;
wherein said tactile control surface is in electronic communication with said digital audio workstation and said software application;
wherein said software application displays said one or more plug-ins on said second electronic data processing device display;
wherein said software application is configured to display a list of said one or more plug-ins, such that a user is able to select one of said one or more plug-ins to use;
wherein said selected audio plug-in is displayed on said second electronic data processing device;
wherein said tactile control surface comprises a plurality of three-dimensional physical input mechanisms;
wherein said plurality of digital representations of analog audio editing controls are configured assignable to said plurality of three-dimensional physical input mechanisms, such that one or more parameters of said selected plug-in are assigned to said plurality of three-dimensional physical input mechanisms and such that said user is able to use said selected plug-in via said tactile control surface to edit said audio information; and
wherein said assigning of said one or more parameters of said selected plug-in are saved;
wherein said assigning of said one or more parameters are saved, such that when said selected plug-in is closed and then reopened, said one or more parameters of said selected plug-in remain assigned to said plurality of three-dimensional physical input mechanisms in the same manner as when saved;
wherein no digital audio workstation presets, templates or projects are required to be loaded to recall said saved assignments; and
wherein said tactile control surface comprises an unassignable rotary input device for setting a value of said one or more parameters.

20. The touch control audio interface system of claim 19, wherein the software application of said second electronic data processing unit is configured to display said selected plug-in at a full-screen position on said second electronic data processing unit display automatically without manual adjustment by said user;
wherein said legend is displayed on said second electronic data processing unit display when said selected plug-in is displayed;
wherein said legend displays to said user of said one or more parameters of said plug-in have been assigned to which three-dimensional physical input mechanisms of said tactile control surface;
wherein said legend is also displayed on said display of said first electronic data processing unit display;
wherein on said display of said first electronic data processing unit said legend is at a bottom border of a graphical user interface of said plug-in regardless of where on said display of said first electronic data processing unit said graphical user interface of said plug-in is;
wherein said tactile control surface comprises a physical legend button that toggles said legend on and off; and
wherein said tactile control surface comprises a dedicated memory push button.
